(19) United States
(12) Patent Application Publication
(10) Pub. No.: US 2019/0092928 A1
(43) Pub. Date: Mar. 28, 2019

(54) RESIN COMPOSITION AND RESIN MOLDED BODY

(71) Applicant: FUJI XEROX CO., LTD., Tokyo (JP)

(72) Inventors: Ryo TANAKA, Kanagawa (JP); Kana MIYAZAKI, Kanagawa (JP); Masahiro MORIYAMA, Kanagawa (JP); Kenji YAO, Kanagawa (JP)

(73) Assignee: FUJI XEROX CO., LTD., Tokyo (JP)

(21) Appl. No.: 15/917,048

(22) Filed: Mar. 9, 2018

(30) Foreign Application Priority Data
Sep. 26, 2017 (JP) 2017-184699

(51) Int. Cl. C08L 1/14; C08L 67/04; B29C 45/00

(52) U.S. Cl. CPC C08L 1/14; C08J 5/046; B29C 45/0001; C08L 67/04

(57) ABSTRACT

A resin composition includes a cellulose ester compound (A) and a core-shell structure polymer (B) having a rubber layer as a core layer and a shell layer on the surface of the rubber layer. The shell layer contains a polymer having a reactive group that reacts with a hydroxyl group of the cellulose ester compound (A).

### CROSS-REFERENCE TO RELATED APPLICATIONS

This application is based on and claims priority under 35 USC 119 from Japanese Patent Application No. 2017-184699 filed Sep. 26, 2017.

### BACKGROUND

### Technical Field

The present invention relates to a resin composition and a resin molded body.

In the related art, various resin compositions are provided and used in different applications. Resin compositions are used particularly in, for example, various parts and housings of home appliances and automobiles. Thermoplastic resins are also used in parts, such as housings, of office machines and electrical and electronic devices.

In recent years, plant-derived resins have been used, and examples of plant-derived resins known in the art include cellulose ester compounds.

By the way, there is known a resin molded body formed of a resin composition (hereinafter referred to as a “specific resin composition (I)”) containing only a “cellulose ester compound (A)” and a “core-shell structure polymer having a rubber layer and a shell layer containing a polymer having no reactive group that reacts with a hydroxyl group of the cellulose ester compound (A)” or a resin composition (hereinafter referred to as a “specific resin composition (II)”) containing only a “cellulose ester compound (A)” and a “core-shell structure polymer having a thermoplastic resin layer and a shell layer containing a polymer having a reactive group that reacts with a hydroxyl group of the cellulose ester compound (A)”.

There is a need to minimize the dimensional change of the resin molded body due to water absorption.

### SUMMARY

According to an aspect of the invention, there is provided a resin composition containing a cellulose ester compound (A) and a core-shell structure polymer (B) having a rubber layer as a core layer and a shell layer on the surface of the rubber layer. The shell layer contains a polymer having a reactive group that reacts with a hydroxyl group of the cellulose ester compound (A).

### DETAILED DESCRIPTION

Exemplary embodiments of the present invention will be described below.

In this specification, the amount of each component in the object refers to, when there are several substances corresponding to the component in the object, the total amount of the substances present in the object, unless otherwise specified.

The expression “polymer of A” encompasses a homopolymer of only A and a copolymer of A and a monomer other than A. Similarly, the expression “copolymer of A and B” encompasses a copolymer of only A and B (hereinafter referred to as a “homocopolymer” for convenience) and a copolymer of A, B, and a monomer other than A and B.

A cellulose ester compound (A), a core-shell structure polymer (B), and a polyester resin (C) are also referred to as a component (A), a component (B), and a component (C), respectively.

### Resin Composition

A resin composition according to an exemplary embodiment includes a cellulose ester compound (A) and a core-shell structure polymer (B) having a rubber layer as a core layer and a shell layer on the surface of the rubber layer. The shell layer contains a polymer having a reactive group that reacts with a hydroxyl group of the cellulose ester compound (A). The resin composition according to the exemplary embodiment may contain other components.

In the related art, the cellulose ester compound (A) (particularly cellulose acylate in which some of hydroxyl groups are substituted with acyl groups) is derived from non-edible sources and is an environmentally friendly resin material because it is a primary derivative without a need of chemical polymerization. The cellulose ester compound (A) has a high elastic modulus among resin materials due to its strong hydrogen bonds. Furthermore, the cellulose ester compound (A) has high transparency since it has an alicyclic structure.

In general, a cellulose ester compound is subject to a large dimensional change caused by swelling during water absorption because water molecules tend to enter between the molecules of the cellulose ester compound. Thus, there is a need to minimize the dimensional change of the resin molded body formed of the specific resin composition (I) or the specific resin composition (II) due to water absorption.

The resin composition according to the exemplary embodiment may further contain a polyester resin (C). When the polyester resin (C) is present, the obtained resin molded body is less subject to a dimensional change caused by water absorption and has high impact resistance. The reason for this is assumed as described below.

When the polyester resin (C) is present, the hydroxyl group or carboxy group at the terminal of the polyester resin (C) bonds to the reactive group contained in the shell layer of the core-shell structure polymer (B). In other words, the polyester resin (C) which has lower water absorbency than the cellulose ester compound (A) and has high rigidity is introduced into molecules, and thus the resin molded body is less subject to a dimensional change and has improved impact resistance.

Hereinafter, the components of the resin composition according to the exemplary embodiment will be described in detail.

### Cellulose Ester Compound (A): Component (A)

The cellulose ester compound (A) is, for example, a resin of a cellulose derivative (cellulose acylate) in which at least some of hydroxyl groups in cellulose are substituted with acyl groups (acylation). Specifically, the cellulose ester compound (A) is, for example, a cellulose derivative represented by general formula (CE).

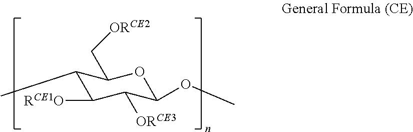

In general formula (CE), R^{CE1}, R^{CE2}, and R^{CE3} each independently represent a hydrogen atom or an acyl group, and n represents an integer of 2 or more. It is noted that at least some of n R^{CE1}'s, n R^{CE2}'s, and n R^{CE3}'s represent an acyl group.

The acyl groups represented by R^{CE1}, R^{CE2}, and R^{CE3} may be acyl groups having 1 to 6 carbon atoms.

In general formula (CE), n is preferably, but not necessarily, 200 or more and 1000 or less, and more preferably 500 or more and 1000 or less.

The expression “in general formula (CE), R^{CE1}, R^{CE2}, and R^{CE3} each independently represent an acyl group” means that at least some of the hydroxyl groups of the cellulose derivative represented by general formula (CE) are acylated.

Specifically, n R^{CE1}'s in the molecules of the cellulose derivative represented by general formula (CE) may be all the same, partially the same, or different from each other. The same applies to n R^{CE2}'s and n R^{CE3}'s.

The cellulose ester compound (A) may have, as an acyl group, an acyl group having 1 to 6 carbon atoms. In this case, the obtained resin molded body tends to rarely undergo a decrease in transparency and to have a high tensile strength at break as compared with the case where the cellulose ester compound (A) has an acyl group having 7 or more carbon atoms.

The acyl group has a structure represented by “—CO—R^{AC}”, where R^{AC} represents a hydrogen atom or a hydrocarbon group (may be a hydrocarbon group having 1 to 5 carbon atoms).

The hydrocarbon group represented by R^{AC} may be a linear, branched, or cyclic hydrocarbon group, and is preferably a linear hydrocarbon group.

The hydrocarbon group represented by R^{AC} may be a saturated hydrocarbon group or an unsaturated hydrocarbon group, and is preferably a saturated hydrocarbon group.

The hydrocarbon group represented by R^{AC} may have atoms (e.g., oxygen, nitrogen) other than carbon and hydrogen, and is preferably a hydrocarbon group composed only of carbon and hydrogen.

Examples of the acyl group include a formyl group, an acetyl group, a propionyl group, a butyryl group (butanoyl group), a propenyl group, and a hexanoyl group.

Among these group, the acyl group is preferably an acyl group having 2 to 4 carbon atoms and more preferably an acyl group having 2 to 3 carbon atoms in order to improve the moldability of the resin composition, suppress a decrease in the transparency of the obtained resin molded body, improve impact resistance, and minimize a dimensional change caused by water absorption.

Examples of the cellulose ester compound (A) include cellulose acetates (cellulose monoacetate, cellulose diacetate (DAC), and cellulose triacetate), cellulose acetate propionate (CAP), and cellulose acetate butyrate (CAB).

The cellulose ester compound (A) may be used alone or in combination of two or more.

Among these substances, the cellulose ester compound (A) is preferably cellulose acetate propionate (CAP) or cellulose acetate butyrate (CAB) and more preferably cellulose acetate propionate (CAP) in order to improve the moldability of the resin composition, suppress a decrease in the transparency of the obtained resin molded body, improve impact resistance, and minimize a dimensional change caused by water absorption.

The degree of polymerization of the cellulose ester compound (A) is preferably 200 or more and 1000 or less and more preferably 500 or more and 1000 or less in order to improve the moldability of the resin composition, suppress a decrease in the transparency of the obtained resin molded body, improve impact resistance, and minimize a dimensional change caused by water absorption.

The degree of polymerization is calculated from the weight-average molecular weight (Mw) in the following manner.

First, the weight-average molecular weight (Mw) of the cellulose ester compound (A) is determined on a polystyrene basis with a gel permeation chromatography system (GPC system: HLC-8320GPC available from Tosoh Corporation, column: TSKgel α-M) using tetrahydrofuran.

Next, the weight-average molecular weight (Mw) of the cellulose ester compound (A) is divided by the molecular weight of the structural unit of the cellulose ester compound (A) to produce the degree of polymerization of the cellulose ester compound (A). For example, when the substituent of cellulose acylate is an acetyl group, the molecular weight of the structural unit is 263 at a degree of substitution of 2.4 and 284 at a degree of substitution of 2.9.

The degree of substitution of the cellulose ester compound (A) is preferably 2.1 or more and 2.8 or less, more preferably 2.2 or more and 2.8 or less, still more preferably 2.3 or more and 2.75 or less, and yet still more preferably 2.35 or more and 2.75 or less, in order to improve the moldability of the resin composition, suppress a decrease in the transparency of the obtained resin molded body, improve impact resistance, and minimize a dimensional change caused by water absorption.

In cellulose acetate propionate (CAP), the ratio of the degree of substitution with the acetyl group to the degree of substitution with the propionyl group (acetyl group/propionyl group) is preferably from 5/1 to 1/20 and more preferably from 3/1 to 1/15 in order to improve the moldability of the resin composition, suppress a decrease in the transparency of the obtained resin molded body, improve impact resistance, and minimize a dimensional change caused by water absorption.

In cellulose acetate butyrate (CAB), the ratio of the degree of substitution with the acetyl group to the degree of substitution with the butyryl group (acetyl group/butyryl group) is preferably from 5/1 to 1/20 and more preferably from 4/1 to 1/15 in order to improve the moldability of the resin composition, suppress a decrease in the transparency of the obtained resin molded body, improve impact resistance, and minimize a dimensional change caused by water absorption.

The degree of substitution indicates the degree at which the hydroxyl groups of cellulose are substituted with acyl groups. In other words, the degree of substitution indicates the degree of acylation of the cellulose ester compound (A). Specifically, the degree of substitution means the average number of hydroxyl groups per molecule substituted with acyl groups among three hydroxyl groups of the D-glucopyranose unit of cellulose acylate.

The degree of substitution is determined from the integration ratio between the peak from hydrogen of cellulose and the peak from the acyl group using H¹-NMR (JMN-ECA available from JEOL RESONANCE).

### Core-Shell Structure Polymer (B): Component (B)

The core-shell structure polymer (B) has a rubber layer as a core layer and a shell layer on the surface of the rubber layer. The shell layer contains a polymer having a reactive group that reacts with a hydroxyl group of the cellulose ester compound (A).

The core-shell structure according to the exemplary embodiment indicates a core-shell structure having a core layer and a shell layer on the surface of the core layer. The core-shell structure polymer according to the exemplary embodiment is, for example, a polymer having a core layer as the innermost layer and a shell layer as the outermost layer (specifically, a polymer in which a polymer having a reactive group that reacts with a hydroxyl group of the cellulose ester compound (A) is bonded to a polymer serving as a core layer by graft polymerization, forming a shell layer).

The core-shell structure polymer may further include one or more other layers (e.g., one to six other layers) between the core layer and the shell layer. When further including other layers, the core-shell structure polymer is a polymer in which plural polymers are bonded to a polymer serving as a core layer by graft polymerization.

### Core Layer

The core layer is a rubber layer. Examples of the rubber layer include, but are not limited to, layers made of (meth)acrylic rubber, silicone rubber, styrene rubber, conjugated diene rubber, a-olefin rubber, nitrile rubber, urethane rubber, polyester rubber, and polyamide rubber, and copolymer rubbers of two or more of these rubbers.

Among these rubbers, the rubber layer is preferably a layer made of, for example, (meth)acrylic rubber, silicone rubber, styrene rubber, conjugated diene rubber, or a-olefin rubber, or a copolymer rubber of two or more of these rubbers.

The rubber layer may be a rubber layer formed by crosslinking through copolymerization using a crosslinker (e.g., divinylbenzene, allyl acrylate, butylene glycol diacrylate).

Examples of (meth)acrylic rubber include a polymer rubber produced by polymerization of a (meth)acrylic component (e.g., a (meth)acrylic acid alkyl ester having 2 to 6 carbon atoms).

Examples of silicone rubber include a rubber formed of a silicone component (e.g., polydimethylsiloxane, polyphenylsiloxane).

Examples of styrene rubber include a polymer rubber produced by polymerization of a styrene component (e.g., styrene, α-methylstyrene).

Examples of conjugated diene rubber include a polymer rubber produced by polymerization of a conjugated diene component (e.g., butadiene, isoprene).

Examples of α-olefin rubber include a polymer rubber produced by polymerization of an α-olefin component (ethylene, propylene, 2-methylpropylene).

Examples of copolymer rubber include a copolymer rubber produced by polymerization of two or more (meth)acrylic components, a copolymer rubber produced by polymerization of a (meth)acrylic component and a silicone component, and a copolymer of a (meth)acrylic component, a conjugated diene component, and a styrene component.

### Shell Layer

The shell layer contains a polymer having a reactive group that reacts with a hydroxyl group of the cellulose ester compound (A).

Examples of the reactive group include a glycidyl group, a dicarboxylic anhydride group, a carboxy group, an isocyanate group, and a hydroxyl group. Among these groups, the polymer is preferably a polymer having at least one reactive group selected from a glycidyl group, a dicarboxylic anhydride group, and a carboxy group.

The polymer having a glycidyl group may be a polymer of a glycidyl group-containing vinyl compound.

Examples of the glycidyl group-containing vinyl compound include glycidyl (meth)acrylate, glycidyl itaconate, diglycidyl itaconate, allyl glycidyl ether, styrene-4-glycidyl ether, and 4-glycidylstyrene. Among these compounds, glycidyl (meth)acrylate is preferred. These compounds may be used alone or in combination of two or more.

The polymer having a dicarboxylic anhydride group may be a polymer of an unsaturated dicarboxylic acid anhydride.

Examples of the unsaturated dicarboxylic acid anhydride include maleic anhydride, itaconic anhydride, glutaconic anhydride, citraconic anhydride, and aconitic anhydride. Among these anhydrides, maleic anhydride is preferred. These anhydrides may be used alone or in combination of two or more.

The polymer having a carboxy group may be a polymer including, in the polymer, one or more structural units having at least one carboxy group.

Examples of the polymer having a carboxy group include a polymer selected from a polymer of (meth)acrylic acid, crotonic acid, a polymer of maleic acid, a polymer of fumaric acid, a polymer of itaconic acid, and polymers of other acids. Among these, a polymer of (meth)acrylic acid is preferred. These polymers may be used alone or in combination of two or more.

The polymer having the reactive group may be at least one polymer selected from a polymer of a glycidyl group-containing vinyl compound, a polymer of an unsaturated dicarboxylic acid anhydride, and a polymer of (meth)acrylic acid. Among these, a polymer of a glycidyl group-containing vinyl compound is particularly preferred from the viewpoint of the impact resistance of the obtained resin composition.

The amount of the polymer of the shell layer in the core-shell structure polymer is preferably 1 mass % or more and 40 mass % or less, more preferably 3 mass % or more and 30 mass % or less, and still more preferably 5 mass % or more and 15 mass % or less relative to the amount of the entire core-shell structure polymer.

The core-shell structure polymer according to the exemplary embodiment may be a commercial product or may be produced by a known method.

Examples of the commercial product include “METABLEN” available from Mitsubishi Chemical Corporation, “Kane Ace” available from Kaneka Corporation, and “PARALOID” available from Dow Chemical. These products may be used alone or in combination of two or more.

Examples of the known method include an emulsion polymerization method. Specifically, the following method is illustrated as a production method. First, a monomer mixture is subjected to emulsion polymerization to produce a core particle (core layer). Next, another monomer mixture is subjected to emulsion polymerization in the presence of the core particle (core layer) to produce a core-shell structure polymer in which a shell layer is formed around the core particle (core layer).

When other layers are formed between the core layer and the shell layer, emulsion polymerization of other monomer mixtures is repeated to produce an intended core-shell structure polymer including the core layer, other layers, and the shell layer.

The average primary particle size of the core-shell structure polymer according to the exemplary embodiment is preferably, but not necessarily, 50 nm or more and 500 nm or less, more preferably 50 nm or more and 400 nm or less, still more preferably 100 nm or more and 300 nm or less, and yet still more preferably 150 nm or more and 250 nm or less, in order to suppress a decrease in the transparency of the obtained resin molded body, improve impact resistance, and minimize a dimensional change caused by water absorption.

The average primary particle size here refers to the value obtained by the following method. Through observation of particles with a scanning electron microscope, the maximum diameter of each primary particle is defined as a primary particle size, and the primary particle sizes of 100 particles are determined and averaged out to a number-average primary particle size. Specifically, the average primary particle size can be determined by observing the dispersion of the core-shell structure polymer in the resin composition with a scanning electron microscope.

### Polyester Resin (C): Component (C)

Examples of the polyester resin (C) include polymers of hydroxyalkanoates (hydroxyalkanoic acids), polycondensates of polycarboxylic acids and polyalcohols, and ring-opened polycondensates of cyclic lactams.

The polyester resin (C) may be an aliphatic polyester resin. Examples of the aliphatic polyester include polyhydroxyalkanoates (polymers of hydroxyalkanoates) and polycondensates of aliphatic diols and aliphatic carboxylic acids.

Among these aliphatic polyesters, polyhydroxyalkanoates are preferred as the polyester resin (C) in order to suppress a decrease in the transparency of the obtained resin molded body, improve impact resistance, and minimize a dimensional change caused by water absorption.

Examples of polyhydroxyalkanoates include a compound having a structural unit represented by general formula (PHA).

The compound having a structural unit represented by general formula (PHA) may include a carboxyl group at each terminal of the polymer chain (each terminal of the main chain) or may include a carboxyl group at one terminal and a different group (e.g., hydroxyl group) at the other terminal.

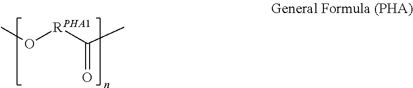

In general formula (PHA), R^{PHA1} represents an alkylene group having 1 to 10 carbon atoms, and n represents an integer of 2 or more.

In general formula (PHA), the alkylene group represented by R^{PHA1} may be an alkylene group having 3 to 6 carbon atoms. The alkylene group represented by R^{PHA1} may be a linear alkylene group or a branched alkylene group, and is preferably a branched alkylene group.

The expression “R^{PHA1} in general formula (PHA) represents an alkylene group” indicates 1) having a [O—R^{PHA1}—C(═O)—] structure where R^{PHA1} represents the same alkylene group, or 2) having plural [O—R^{PHA1}—C(═O)—] structures where R^{PHA1} represents different alkylene groups (R^{PHA1} represents alkylene groups different from each other in branching or the number of carbon atoms (e.g., a [O—R^{PHA1A}—C(═O)—][O—R^{PHA1B}—C(═O)—] structure).

The polyhydroxyalkanoate may be a homopolymer of one hydroxyalkanoate (hydroxyalkanoic acid) or may be a copolymer of two or more hydroxyalkanoates (hydroxyalkanoic acids).

In general formula (PHA), the upper limit of n is not limited, and n is, for example, 20,000 or less. For the range of n, n is preferably 500 or more and 10,000 or less, and more preferably 1,000 or more and 8,000 or less.

Examples of polyhydroxyalkanoates include homopolymers of hydroxyalkanoic acids (e.g., lactic acid, 2-hydroxybutyric acid, 3-hydroxybutyric acid, 4-hydroxybutyric acid, 2-hydroxy-3-methylbutyric acid, 2-hydroxy-3,3-dimethylbutyric acid, 3-hydroxyvaleric acid, 4-hydroxyvaleric acid, 5-hydroxyvaleric acid, 3-hydroxyhexanoic acid, 2-hydroxyhexanoic acid, 2-hydroxyisohexanoic acid, 6-hydroxyhexanoic acid, 3-hydroxypropionic acid, 3-hydroxy-2,2-dimethylpropanoic acid, and 3-hydroxyhexanoic acid, 2-hydroxy-n-octanoic acid), and copolymers of two or more of these hydroxyalkanoic acids.

Among these, the polyhydroxyalkanoate is preferably a homopolymer of a branched hydroxyalkanoic acid having 2 to 4 carbon atoms, and a homocopolymer of a branched hydroxyalkanoic acid having 2 to 4 carbon atoms and a branched hydroxyalkanoic acid having 5 to 7 carbon atoms, more preferably a homopolymer of a branched hydroxyalkanoic acid having 3 carbon atoms (i.e., polylactic acid), or a homocopolymer of 3-hydroxybutyric acid and 3-hydroxyhexanoic acid (i.e., polyhydroxybutyrate-hexanoate), and still more preferably a homopolymer of a branched hydroxyalkanoic acid having 3 carbon atoms (i.e., polylactic acid), in order to suppress a decrease in the transparency of the obtained resin molded body, improve impact resistance, and minimize a dimensional change caused by water absorption.

The number of carbon atoms in hydroxyalkanoic acid is a number inclusive of the number of the carbon of the carboxyl group.

Examples of the polylactic acid include poly-L-lactic acid having L-lactic acid as a structural unit, poly-D-lactic acid having D-lactic acid as a structural unit, poly-DL-lactic acid having L-lactic acid and D-lactic acid as structural units, and mixtures thereof. At least one of L-lactic acid and D-lactic acid may be copolymerized with a monomer other than lactic acids.

The polymerization method for polylactic acid is not limited, and polylactic acid may be produced by any of known polymerization methods such as condensation polymerization and ring-opening polymerization. For example, for condensation polymerization, polylactic acid is produced so as to have a certain composition by direct dehydration polycondensation of L-lactic acid, D-lactic acid, or a mixture of these. For ring-opening polymerization, a lactic acid-based resin is produced as a polylactic acid having a certain composition as follows: mixing lactide, which is a cyclic dimer of lactic acid, with a polymerization modifier as needed; and polymerizing lactide using a catalyst. Lactide exists as one of L-lactide, which is a dimer of L-lactic acid, D-lactide, which is a dimer of D-lactic acid, and DL-lactide formed of L-lactic acid and D-lactic acid.

In polyhydroxybutyrate-hexanoate, the copolymerization ratio of 3-hydroxyhexanoic acid (3-hydroxyhexanoate) to a copolymer of 3-hydroxybutyric acid (3-hydroxybutyrate) and 3-hydroxyhexanoic acid (3-hydroxyhexanoate) is preferably 3 mol % or more and 20 mol % or less, more preferably 4 mol % or more and 15 mol % or less, and still more preferably 5 mol % or more and 12 mol % or less, in order to suppress a decrease in the transparency of the obtained resin molded body, improve impact resistance, and minimize a dimensional change caused by water absorption.

The copolymerization ratio of 3-hydroxyhexanoic acid (3-hydroxyhexanoate) is determined using H¹-NMR such that the ratio of the hexanoate is calculated from the integrated values of the peaks from the hexanoate terminal and the butyrate terminal.

The weight-average molecular weight (Mw) of the polyester resin (C) may be 10,000 or more and 1,000,000 or less (preferably 50,000 or more and 800,000 or less, more preferably 100,000 or more and 600,000 or less), in order to suppress a decrease in the transparency of the obtained resin molded body, improve impact resistance, and minimize a dimensional change caused by water absorption.

The weight-average molecular weight of the polyester resin (C) is a value determined by gel permeation chromatography (GPC). Specifically, the determination of the molecular weight by GPC is carried out using HLC-8320GPC available from Tosoh Corporation as a measurement system, columns available from Tosoh Corporation, TSKgel GMHHR-M+TSKgel GMHHR-M (7.8 mm I.D., 30 cm), and a chloroform solvent. The weight-average molecular weight (Mw) is calculated from the molecular weight calibration curve created on the basis of the obtained measurement results using a monodisperse polystyrene standard.

### Amount or Mass Ratio for Components (A) to (C)

The amount or the mass ratio of each component will be described. The amount or the mass ratio of each component may be in the following range in order to suppress a decrease in the transparency of the obtained resin molded body, improve impact resistance, and minimize a dimensional change caused by water absorption. The shortened name for each component is as described below.
Component (A)=cellulose ester compound (A)
Component (B)=core-shell structure polymer (B)
Component (C)=polyester resin (C)

The ratio [(B)/((A)+(B))] of the mass of the component (B) to the total mass of the component (A) and the component (B) is preferably 0.03 or more and 0.25 or less, more preferably 0.05 or more and 0.2 or less, and still more preferably 0.07 or more and 0.15 or less.

The ratio [(C)/((A)+(B)+(C))] of the mass of the component (C) to the total mass of the component (A), the component (B), and the component (C) is preferably 0.025 or more and 0.185 or less, more preferably 0.04 or more and 0.12 or less, and still more preferably 0.06 or more and 0.09 or less.

The amount of the component (A) relative to the resin composition is preferably 50 mass % or more, more preferably 60 mass % or more, and still more preferably 70 mass % or more, in order to suppress a decrease in the transparency of the obtained resin molded body, improve impact resistance, and minimize a dimensional change caused by water absorption.

### Other Components

The resin composition according to the exemplary embodiment may contain other components. Examples of other components include a flame retardant, a compatibilizer, an antioxidant, a release agent, a light resisting agent, a weathering agent, a colorant, a pigment, a modifier, an anti-drip agent, an antistatic agent, a hydrolysis inhibitor, a filler, and reinforcing agents (e.g., glass fiber, carbon fiber, talc, clay, mica, glass flake, milled glass, glass beads, crystalline silica, alumina, silicon nitride, aluminum nitride, and boron nitride).

As needed, components (additives), such as an acid acceptor for avoiding release of acetic acid and a reactive trapping agent, may be added. Examples of the acid acceptor include oxides, such as magnesium oxide and aluminum oxide; metal hydroxides, such as magnesium hydroxide, calcium hydroxide, aluminum hydroxide, and hydrotalcite; calcium carbonate; and talc.

Examples of the reactive trapping agent include epoxy compounds, acid anhydride compounds, and carbodiimides.

The amount of each of these components may be 0 mass % or more and 5 mass % or less relative to the amount of the entire resin composition. The expression “0 mass %” means that the resin composition is free of a corresponding one of other components.

Examples of other components include a plasticizer in addition to the above-described components. The plasticizer is any known plasticizer. Examples of the plasticizer include an adipic acid ester-containing compound, a polyether ester compound, a sebacic acid ester compound, a glycol ester compound, acetate ester, a dibasic acid ester compound, a phosphoric acid ester compound, a phthalic acid ester compound, camphor, citric acid ester, stearic acid ester, metallic soap, polyol, and polyalkylene oxide.

Among these compounds, an adipic acid ester-containing compound and a polyether ester compound are preferred, and an adipic acid ester-containing compound is more preferred.

The adipic acid ester-containing compound (a compound containing adipic acid ester) refers to a compound of only adipic acid ester or a mixture of adipic acid ester and a component other than adipic acid ester (a compound different from adipic acid ester). The adipic acid ester-containing compound may contain 50 mass % or more of adipic acid ester relative to the total mass of all components in the compound.

The amount of the plasticizer relative to the resin composition according to the exemplary embodiment is preferably 15 mass % or less, more preferably 10 mass % or less, and still more preferably 5 mass % or less, in order to suppress a decrease in the transparency of the obtained resin molded body, improve impact resistance, and minimize a dimensional change caused by water absorption.

The resin composition may be free of a plasticizer. In other words, the amount of the plasticizer relative to the resin composition may be 0 mass %. When the resin composition contains a plasticizer, the resin composition tends to be subject to a large dimensional change caused by water absorption.

The resin composition according to the exemplary embodiment may contain resins other than the above-described resins (the cellulose ester compound (A), the core-shell structure polymer (B), and the polyester resin (C)). When other resins are present, the amount of other resins relative to the amount of the entire resin composition is 10 mass % or less, and preferably less than 5 mass %. More preferably, the resin composition is free of other resins (i.e., 0 mass %).

Examples of other resins include thermoplastic resins known in the art. Specific examples include polycarbonate resin; polypropylene resin; polyester resin; polyolefin resin; polyester-carbonate resin; polyphenylene ether resin; polyphenylene sulfide resin; polysulfone resin; polyether sulfone resin; polyarylene resin; polyetherimide resin; polyacetal resin; polyvinyl acetal resin; polyketone resin; polyether ketone resin; polyether ether ketone resin; polyaryl ketone resin; polyether nitrile resin; liquid crystal resin; polybenzimidazole resin; polyparabanic acid resin; a vinyl polymer or a vinyl copolymer produced by polymerizing or copolymerizing one or more vinyl monomers selected from the group consisting of an aromatic alkenyl compound, a methacrylic acid ester, an acrylic acid ester, and a vinyl cyanide compound; a diene-aromatic alkenyl compound copolymer; a vinyl cyanide-diene-aromatic alkenyl compound copolymer; an aromatic alkenyl compound-diene-vinyl cyanide-N-phenylmaleimide copolymer; a vinyl cyanide-(ethylene-diene-propylene (EPDM))-aromatic alkenyl compound copolymer; a polyvinyl chloride resin; and a chlorinated polyvinyl chloride resin. These resins may be used alone or in combination of two or more.

### Method for Producing Resin Composition

A method for producing a resin composition according to the exemplary embodiment includes, for example, a step of preparing a resin composition containing the cellulose ester compound (A) and the core-shell structure polymer (B) having a rubber layer as a core layer and a shell layer on the surface of the rubber layer. The shell layer contains a polymer having a reactive group that reacts with a hydroxyl group of the cellulose ester compound (A).

The resin composition according to the exemplary embodiment is produced by melt-kneading a mixture containing the cellulose ester compound (A), the core-shell structure polymer (B), and as needed, the polyester resin (C) or other resins, and other components and the like. Alternatively, the resin composition according to the exemplary embodiment is produced by, for example, dissolving the above-described components in a solvent.

An apparatus used for melt kneading is, for example, a known apparatus. Specific examples of the apparatus include a twin screw extruder, a Henschel mixer, a Banbury mixer, a single screw extruder, a multi-screw extruder, and a co-kneader.

### Resin Molded Body

A resin molded body according to an exemplary embodiment contains the resin composition according to the exemplary embodiment. In other words, a resin molded body according to an exemplary embodiment has the same composition as the resin composition according to the exemplary embodiment.

The method for molding the resin molded body according to the exemplary embodiment may be injection molding in terms of a high degree of freedom in shaping. For this point, the resin molded body may be an injection-molded body obtained by injection molding.

The cylinder temperature in injection molding is, for example, 160° C. or higher and 280° C. or lower, and preferably 200° C. or higher and 240° C. or lower. The mold temperature in injection molding is, for example, 40° C. or higher and 90° C. or lower, and preferably 60° C. or higher and 80° C. or lower.

Injection molding may be performed using a commercially available apparatus, such as NEX 500 available from Nissei Plastic Industrial Co., Ltd., NEX 150 available from Nissei Plastic Industrial Co., Ltd., NEX 70000 available from Nissei Plastic Industrial Co., Ltd., PNX 40 available from Nissei Plastic Industrial Co., Ltd., and SE50D available from Sumitomo Heavy Industries.

The molding method used for producing the resin molded body according to the exemplary embodiment is not limited to injection molding described above. Examples of the molding method include extrusion molding, blow molding, heat press molding, calendar molding, coating molding, cast molding, dipping molding, vacuum molding, and transfer molding.

The resin molded body according to the exemplary embodiment may have a haze value of 10% or lower (preferably 7% or lower) when having a thickness of 2 mm. When the resin molded body having a thickness of 2 mm has a haze value of 10% or lower, the resin molded body is said to have transparency.

The haze value of the resin molded body is ideally 0%, but may be 0.5% or higher from a manufacturing viewpoint.

The haze value of the resin molded body is determined by the method described in Examples.

The resin molded body according to the exemplary embodiment is used in various applications, such as electrical and electronic devices, office machines, home appliances, automotive interior materials, toys, and containers. More specifically, the resin molded body is used in housings of electrical and electronic devices and home appliances; various parts of electrical and electronic devices and home appliances; automotive interior parts; block assembly toys; plastic model kits; cases for CD-ROMs, DVDs, and the like; tableware; drink bottles; food trays; wrapping materials; films; and sheets.

### EXAMPLES

The present invention will be described below in more detail by way of Examples, but the present invention is not limited by these Examples. The unit “part(s)” refers to “part(s) by mass” unless otherwise specified.

### Preparation of Cellulose Ester Compound (A)

CE1: “CAP-482-20 (Eastman Chemical Company)”
CE2: “CAB-171-15 (Eastman Chemical Company)”
CE3: “CAB-381-20 (Eastman Chemical Company)”
CE4: “CAB-500-5 (Eastman Chemical Company)”
CE5: “L-50 (Daicel Corporation)”, DAC

The properties of the cellulose ester compound (A) are summarized in Table 1. In Table 1, DPw represents the weight-average degree of polymerization. DS (Ac), DS (Pr), and DS (Bt) represent the degree of substitution with an acetyl group, the degree of substitution with a propionyl group, and the degree of substitution with a butyryl group, respectively.

TABLE 1

| Cellulose Ester | | | | |
|---|---|---|---|---|
| Compound (A) | DPw | DS(Ac) | DS(Pr) | DS(Bt) |
| CE1 | 716 | 0.18 | 2.49 | — |
| CE2 | 754 | 2.07 | — | 0.73 |
| CE3 | 890 | 1.05 | — | 1.74 |
| CE4 | 625 | 0.17 | — | 2.64 |
| CE5 | 570 | 2.45 | — | — |

### Preparation of Core-Shell Structure Polymer (B)

B1: “METABLEN S-2200 (Mitsubishi Chemical Corporation)”, a core-shell structure polymer (a polymer including a core layer made of a “silicone-acrylic rubber” and a shell layer made of a “copolymer of methyl methacrylate and glycidyl methacrylate”), with a reactive group

B2: “PARALOID EXL-2314 (Dow Chemical Company)”, a core-shell structure polymer (a polymer including a core layer made of a “polymer containing polybutylacrylate as a main component” and a shell layer made of a “copolymer of methyl methacrylate and glycidyl methacrylate”), with a reactive group

B3: “METABLEN S-2006 (Mitsubishi Chemical Corporation)”, a core-shell structure polymer, average primary particle size 200 nm, (a polymer including a core layer made of a “silicone-acrylic rubber” and a shell layer made of a “polymer of methyl methacrylate”), with no reactive group

B4: “PARALOID EXL-2330 (Dow Chemical Company)”, a core-shell structure polymer (a polymer including a core layer made of a “polymer containing polybutylacrylate as a main component” and a shell layer made of a “polymer of methyl methacrylate”), with no reactive group

B5: “PARALOID EXL-2602 (Dow Chemical Company)”, a core-shell structure MBS rubber, with no reactive group

B6: prototype, a core-shell structure polymer (a polymer including a core layer made of a “homopolymer rubber containing polybutylacrylate as a main component” and a shell layer made of a “copolymer of methyl methacrylate and maleic anhydride”), with a reactive group

### Polyester Resin (C) and Preparation of Other Resins

C1: “DELPET 720V (Asahi Kasei Corporation)”, polymethyl methacrylate (PMMA)

C2: “Ingeo Biopolymer 3001D (NatureWorks)”, polylactic acid (PLA)

C3: “METABLEN P-1900 (Mitsubishi Chemical Corporation)”, a polymer produced by polymerization of a glycidyl methacrylate unit serving as a main component, (epoxy equivalent: 158 g/eq)

C4: “AONILEX X151A (Kaneka Corporation)”, a homocopolymer (PHBH) of 3-hydroxybutyric acid (3-hydroxybutyrate) and 3-hydroxyhexanoic acid (3-hydroxyhexanoate)

### Preparation of Other Components

PL1: “DAIFATTY-101 (Daihachi Chemical Industry Co., Ltd.)”, adipic acid ester-containing compound, plasticizer

PL2: “DOA (Daihachi Chemical Industry Co., Ltd.,)”, 2-ethylhexyl adipate, plasticizer

### Examples 1 to 18, Comparative Examples 1 to 8

### Kneading and Injection Molding

A resin composition (pellets) is produced using a twin screw kneader (LTE20-44 available from Labtech Engineering) at the preparation composition ratio shown in Table 2 and the cylinder temperature shown in Table 2.

The produced pellets are molded into the following resin molded bodies (1) and (2) using an injection molding machine (NEX 5001 available from Nissei Plastic Industrial Co., Ltd.) at an injection peak pressure of 180 MPa or lower, the cylinder temperature shown in Table 2, and a mold temperature of 60° C.
(1): ISO multi-purpose dumbbell test piece (dimensions of measurement part: 10 mm wide, 4 mm thick)
(2): D12 small plate (dimensions: 60 mm×60 mm, 2 mm thick)

### Evaluation

The produced molded bodies are subjected to the following evaluation. The evaluation results are shown in Table 2.

### Water-Absorption Dimensional Change Percentage

The produced D12 small plate is left to stand at room temperature for 24 hours or longer after molding. The lengths of the four sides of the plate are measured, and the average length in the machine direction (MD) and the average length in the transverse direction (TD) (a direction perpendicular to the MD) are calculated as the dimensions before water absorption. The plate is immersed in water at room temperature for 72 hours, and the average length in the machine direction (MD) and the average length in the transverse direction (TD) are similarly calculated as the dimensions after water absorption. From these dimensions, the water-absorption dimensional change percentages in two directions are calculated in accordance with the following formula, and the average of the water-absorption dimensional change percentages is obtained as a water-absorption dimensional change percentage.

Water-absorption dimensional change percentage (%)={(dimension after water absorption)/(dimension before water absorption)−1}×100

### Tensile Modulus of Elasticity

The tensile modulus of elasticity is measured for the produced ISO multi-purpose dumbbell test piece by a method in conformity with ISO527 using a universal tester “autograph AG-Xplus available from Shimadzu Corporation”.

### Tensile Strain at Break

The tensile strain at break is measured for the produced ISO multi-purpose dumbbell test piece by a method in conformity with ISO527 using a universal tester “autograph AG-Xplus available from Shimadzu Corporation”.

### Haze Value

The haze value is measured for the produced D12 small plate using a haze meter (NDH200 available from Nippon Denshoku Industries Co., Ltd.).

### Charpy Impact Strength

The produced ISO multi-purpose dumbbell test piece is notched with a notching tool (notching machine available from Toyo Seiki Seisaku-sho, Ltd.). The Charpy impact strength is measured for the notched ISO multi-purpose dumbbell test piece by a method in conformity with ISO-179-1 (2010) using a digital impact tester (DG-UB available from Toyo Seiki Seisaku-sho, Ltd.).

TABLE 2

| | | | | | | | | Cylinder | Water- | | Tensile | | |
|---|---|---|---|---|---|---|---|---|---|---|---|---|---|
| | | | | | | | | Temper- | Absorption | | Modulus | Tensile | |
| | | | Core-Shell | | | | | ature | Dimen- | | of | Strain | Charpy |
| | | | Structure | | Polyester Resin | | Other | (° C.) in | sional | | Elastic- | at | Impact |
| | | Cellulose | Polymer | B/ | (C) or | | Com- | Kneading | Change | Haze | ity | Break | Strength |
| | | Ester (A) | (B) | (A + B) | Other Resins | | ponents | and Molding | (%) | (%) | (MPa) | (%) | (kJ/m²) |
| Example | 1 | CE1 = 100 | B1 = 5 | 0.048 | — | | — | 220 | 0.57 | 5.6 | 1780 | 39 | 12 |
| Example | 2 | CE1 = 100 | B1 = 10 | 0.091 | — | | — | 220 | 0.48 | 6.2 | 1720 | 43 | 19.1 |
| Example | 3 | CE1 = 100 | B1 = 25 | 0.2 | — | | — | 220 | 0.45 | 5.8 | 1620 | 41 | 18.5 |
| Example | 4 | CE1 = 100 | B1 = 3 | 0.029 | — | | — | 220 | 0.68 | 5.5 | 1800 | 38 | 9.7 |
| Example | 5 | CE1 = 100 | B1 = 40 | 0.286 | — | | — | 220 | 0.45 | 7.2 | 1570 | 29 | 17.1 |
| Example | 6 | CE2 = 100 | B1 = 10 | 0.091 | — | | — | 220 | 0.53 | 6.2 | 2220 | 31 | 13.1 |
| Example | 7 | CE3 = 100 | B1 = 10 | 0.091 | — | | — | 220 | 0.49 | 6.5 | 1770 | 44 | 18.4 |
| Example | 8 | CE4 = 100 | B1 = 10 | 0.091 | — | | — | 220 | 0.34 | 6.6 | 1320 | 50 | 20.5 |
| Example | 9 | CE5 = 100 | B1 = 14 | 0.123 | — | | PL1 = 25 | 230 | 0.69 | 9.4 | 2080 | 25 | 12.5 |
| Example | 10 | CE1 = 100 | B2 = 10 | 0.091 | — | | — | 220 | 0.45 | 5.6 | 1790 | 47 | 19.3 |
| Example | 11 | CE1 = 100 | B6 = 10 | 0.091 | — | | — | 220 | 0.53 | 6.9 | 1780 | 38 | 16.2 |
| Compar- | 1 | CE1 = 100 | B3 = 10 | 0.091 | — | | — | 220 | 0.75 | 6.9 | 1750 | 45 | 15.7 |
| ative | | | | | | | | | | | | | |
| Example | | | | | | | | | | | | | |
| Compar- | 2 | CE1 = 100 | B4 = 10 | 0.091 | — | | — | 220 | 0.76 | 6.2 | 1740 | 40 | 15.2 |
| ative | | | | | | | | | | | | | |
| Example | | | | | | | | | | | | | |
| Compar- | 3 | CE1 = 100 | B5 = 10 | 0.091 | — | | — | 220 | 0.73 | 11.1 | 1720 | 41 | 15.4 |
| ative | | | | | | | | | | | | | |
| Example | | | | | | | | | | | | | |
| Compar- | 4 | CE1 = 100 | B3 = 10 | 0.091 | C3 = 2 | — | — | 230 | 0.73 | 7.4 | 1700 | 40 | 16.1 |
| ative | | | | | | | | | | | | | |
| Example | | | | | | | | | | | | | |
| Compar- | 5 | CE1 = 100 | B4 = 10 | 0.091 | C3 = 2 | — | — | 230 | 0.71 | 6.8 | 1720 | 38 | 15 |
| ative | | | | | | | | | | | | | |
| Example | | | | | | | | | | | | | |
| Compar- | 6 | CE5 = 100 | B5 = 14 | 0.123 | — | | PL1 = 25 | 230 | 0.84 | 15.8 | 2030 | 24 | 11.5 |
| ative | | | | | | | | | | | | | |
| Example | | | | | | | | | | | | | |
| Example | 12 | CE1 = 100 | B1 = 10 | 0.091 | C1 = 5 | C2 = 5 | — | 220 | 0.35 | 6.4 | 1830 | 40 | 18 |
| Example | 13 | CE1 = 100 | B2 = 10 | 0.091 | C1 = 5 | C2 = 5 | — | 220 | 0.33 | 5.8 | 1850 | 37 | 16.6 |
| Example | 14 | CE1 = 100 | B1 = 10 | 0.091 | C1 = 5 | C4 = 5 | — | 220 | 0.37 | 6.5 | 1640 | 42 | 17.9 |
| Example | 15 | CE1 = 100 | B2 = 10 | 0.091 | C1 = 5 | C4 = 5 | — | 220 | 0.37 | 6.6 | 1660 | 41 | 17.7 |
| Compar- | 7 | CE1 = 100 | B3 = 10 | 0.091 | C1 = 5 | C2 = 5 | — | 220 | 0.74 | 7.1 | 1780 | 41 | 12.6 |
| ative | | | | | | | | | | | | | |
| Example | | | | | | | | | | | | | |
| Compar- | 8 | CE1 = 100 | B4 = 10 | 0.091 | C1 = 5 | C2 = 5 | — | 220 | 0.71 | 6.5 | 1800 | 36 | 11.5 |
| ative | | | | | | | | | | | | | |
| Example | | | | | | | | | | | | | |
| Example | 16 | CE1 = 100 | B1 = 10 | 0.091 | C1 = 10 | — | — | 220 | 0.45 | 14.0 | 1820 | 35 | 17.1 |
| Example | 17 | CE1 = 100 | B2 = 10 | 0.091 | C1 = 10 | — | — | 220 | 0.43 | 14.1 | 1860 | 37 | 16.2 |

| | | | | | | | | | | | | |
|---|---|---|---|---|---|---|---|---|---|---|---|---|
| Example | 18 | CE1 = 88 | B1 = 10 | 0.1 | — | PL2 = 12 | 200 | 0.6 | 9.8 | 1390 | 51 | 20.1 |

In Table 2, the materials of each composition and the proportion of each material are described in table cells in the form of “material=parts by mass”.

For example, “CE1=100” is described in one cell associated with the cellulose ester compound (A) in Example 1 and indicates that 100 parts by mass of a cellulose ester compound “CE1” is mixed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
a cellulose ester compound (A); and
a core-shell structure polymer (B) having a rubber layer as a core layer and a shell layer on a surface of the rubber layer, the shell layer containing a polymer having a reactive group that reacts with a hydroxyl group of the cellulose ester compound (A).

2. The resin composition according to claim 1, wherein the cellulose ester compound (A) is at least one compound selected from cellulose acetate propionate (CAP) and cellulose acetate butyrate (CAB).

3. The resin composition according to claim 2, wherein the cellulose ester compound (A) is cellulose acetate propionate (CAP).

4. The resin composition according to claim 1, wherein the shell layer in the core-shell structure polymer (B) contains, as the polymer having the reactive group, a polymer having at least one reactive group selected from a glycidyl group, a dicarboxylic anhydride group, and a carboxy group.

5. The resin composition according to claim 4, wherein the shell layer in the core-shell structure polymer (B) contains, as the polymer having the reactive group, at least one polymer selected from a polymer of a glycidyl group-containing vinyl compound, a polymer of an unsaturated dicarboxylic acid anhydride, and a polymer of (meth)acrylic acid.

6. The resin composition according to claim 5, wherein the shell layer in the core-shell structure polymer (B) contains, as the polymer having the reactive group, a polymer of a glycidyl group-containing vinyl compound.

7. The resin composition according to claim 1, wherein a ratio of a mass of the core-shell structure polymer (B) to a total mass of the cellulose ester compound (A) and the core-shell structure polymer (B) is 0.03 or more and 0.25 or less.

8. The resin composition according to claim 6, wherein a ratio of a mass of the core-shell structure polymer (B) to a total mass of the cellulose ester compound (A) and the core-shell structure polymer (B) is 0.03 or more and 0.25 or less.

9. The resin composition according to claim 7, wherein an amount of the cellulose ester compound (A) relative to the resin composition is 50 mass % or more.

10. The resin composition according to claim 1, further comprising a polyester resin (C).

11. The resin composition according to claim 10, wherein the polyester resin (C) is polyhydroxyalkanoate.

12. The resin composition according to claim 11, wherein the polyester resin (C) is polylactic acid.

13. A resin molded body comprising the resin composition according to claim 1.

14. The resin molded body according to claim 13, wherein the resin molded body has a haze value of 10% or lower when having a thickness of 2 mm.

15. The resin molded body according to claim 13, wherein the resin molded body is an injection-molded body.
